(19) United States
(12) Patent Application Publication
(10) Pub. No.: US 2019/0279507 A1
(43) Pub. Date: Sep. 12, 2019

(54) VEHICLE DISPLAY CONTROL DEVICE, VEHICLE DISPLAY CONTROL METHOD, AND VEHICLE DISPLAY CONTROL PROGRAM

(71) Applicant: HONDA MOTOR CO., LTD., Minato-ku, Tokyo (JP)

(72) Inventors: Kentaro Ishisaka, Wako-shi (JP); Yoshitaka Mimura, Wako-shi (JP)

(21) Appl. No.: 16/462,949

(22) PCT Filed: Nov. 25, 2016
(86) PCT No.: PCT/JP2016/084921

§ 371 Date: May 22, 2019

(51) Int. Cl. G08G 1/0967; B60W 50/00; B60W 50/14; B60Q 9/00

(52) U.S. Cl. CPC G08G 1/0967; B60W 50/0097; B60W 2050/146; B60Q 9/00; B60W 2550/20; B60W 50/14

(57) ABSTRACT

A vehicle display control device includes: a prediction and derivation unit configured to predict a future action of a nearby vehicle near an own vehicle and derive an index value obtained by quantifying a possibility of the predicted future action being taken; and a display controller configured to cause a display to display an image in which an image element according to the index value obtained by quantifying the possibility of the future action being taken for each nearby vehicle and derived by the prediction and derivation unit is associated with the nearby vehicle.

### TECHNICAL FIELD

The present invention relates to a vehicle display control device, a vehicle display control method, and a vehicle display control program.

### BACKGROUND ART

In the related art, technologies for predicting actions of vehicles near an own vehicle are known (for example, see Patent Document 1).

### CITATION LIST

### Patent Document

### Patent Document 1

Japanese Unexamined Patent Application, First Publication No. 2015-230511

### SUMMARY OF INVENTION

### Technical Problem

However, in the technologies of the related art, control of acceleration or deceleration speeds or the like of the own vehicle is performed without an occupant of the own vehicle ascertaining predicted actions of nearby vehicles in some cases. As a result, the occupant of the vehicle may feel uneasy in some cases.

The present invention is devised in view of such circumstances and one object of the present invention is to provide a vehicle display control device, a vehicle display control method, and a vehicle display control program capable of providing a sense of security to a vehicle occupant.

### Solution to Problem

According to a first aspect of the present invention, there is provided a vehicle display control device including: a prediction and derivation unit configured to predict a future action of a nearby vehicle near an own vehicle and derive an index value obtained by quantifying a possibility of the predicted future action being taken; and a display controller configured to cause a display to display an image in which an image element according to the index value obtained by quantifying the possibility of the future action being taken for each nearby vehicle and derived by the prediction and derivation unit is associated with the nearby vehicle.

According to a second aspect of the present invention, in the vehicle display control device according to the first aspect, the prediction and derivation unit is configured to predict a plurality of future actions of the nearby vehicle and derive the index value of each of the plurality of predicted future actions. The display controller is configured to cause the display to display the image in which the image element according to the index value of each future action of the nearby vehicle and derived by the prediction and derivation unit is associated with the nearby vehicle.

According to a third aspect of the present invention, in the vehicle display control device according to the second aspect, the display controller is configured to change an expression aspect of the corresponding image element between an action in a direction in which an influence on the own vehicle is less than a standard value and an action in a direction in which the influence on the own vehicle is greater than the standard value among a plurality of future actions of the nearby vehicle.

According to a fourth aspect of the present invention, in the vehicle display control device according to claim 2, the display controller is configured to cause the display to display an image in which an image element according to the index value corresponding to an action in a direction in which an influence on the own vehicle is greater than the standard value among the plurality of future actions of the nearby vehicle is associated with the nearby vehicle.

According to a fifth aspect of the present invention, in the vehicle display control device according to claim 4, the display controller is further configured to cause the display to display an image in which an image element according to the index value corresponding to an action in a direction in which the influence on the own vehicle is less than the standard value among the plurality of future actions of the nearby vehicle is associated with the nearby vehicle.

According to a sixth aspect of the present invention, in the vehicle display control device according to the third aspect, the action in the direction in which the influence on the own vehicle is greater than the standard value is an action in which the nearby vehicle relatively approaches the own vehicle.

According to a seventh aspect of the present invention, in the vehicle display control device according to the third aspect, the action in the direction in which the influence on the own vehicle is greater than the standard value is an action in which the nearby vehicle intrudes in front of the own vehicle.

According to an eighth aspect of the present invention, in the vehicle display control device according to the first aspect, the display controller is configured to change an expression aspect of the image element step by step or continuously with a change in the index value corresponding to the future action of each nearby vehicle and derived by the prediction and derivation unit.

According to a ninth aspect of the present invention, in the vehicle display control device according to the first aspect, the prediction and derivation unit is configured to predict a future action of the nearby vehicle of which an influence on the own vehicle is greater than a standard value.

According to a tenth aspect of the present invention, in the vehicle display control device according to claim 9, the nearby vehicle of which the influence on the own vehicle is greater than the standard value includes at least one of a front traveling vehicle traveling immediately in front of the own vehicle and, in a lane adjacent to a lane in which the own vehicle is traveling, a vehicle traveling in front of the own vehicle or a vehicle traveling side by side with the own vehicle.

According to an eleventh aspect of the present invention, in the vehicle display control device according to the first aspect, the prediction and derivation unit is configured to derive the index value according to a relative speed of the own vehicle to the nearby vehicle, an inter-vehicle distance between the own vehicle and the nearby vehicle, or acceleration or deceleration of the nearby vehicle.

According to a twelfth aspect of the present invention, in the vehicle display control device according to a first aspect, the prediction and derivation unit is configured to derive the index value according to a situation of a lane in which the nearby vehicle is traveling.

According to a thirteenth aspect of the present invention, there is provided a vehicle display control method of causing an in-vehicle computer mounted in a vehicle that includes a display to: predict a future action of a nearby vehicle near an own vehicle; derive an index value obtained by quantifying a possibility of the predicted future action being taken; and cause the display to display an image in which an image element according to the derived index value obtained by quantifying the possibility of the future action being taken for each nearby vehicle is associated with the nearby vehicle.

According to a fourteenth aspect of the present invention, there is provided a vehicle display control program causing an in-vehicle computer mounted in a vehicle that includes a display to perform: a process of predicting a future action of a nearby vehicle near an own vehicle; a process of deriving an index value obtained by quantifying a possibility of the predicted future action being taken; and a process of causing the display to display an image in which an image element according to the derived index value obtained by quantifying the possibility of the future action being taken for each nearby vehicle is associated with the nearby vehicle.

### Advantageous Effects of Invention

According to each of the above aspects of the present invention, it is possible to provide a sense of security to a vehicle occupant by predicting a future action of a nearby vehicle near a own vehicle, deriving an index value obtained by quantifying a possibility of a predicted future action being taken, and causing a display to display an image in which an image element according to the derived index value obtained by quantifying the possibility of the future action being taken for each nearby vehicle is associated with the nearby vehicle.

### BRIEF DESCRIPTION OF DRAWINGS

FIG. 1 is a diagram showing a configuration of a vehicle system 1 including a vehicle display control device 100 according to a first embodiment.

FIG. 2 is a flowchart showing an example of a flow of a series of processes by the vehicle display control device 100 according to the first embodiment.

FIG. 3 is a diagram showing examples of occurrence probabilities when an azimuth centering on a standard point of a monitoring vehicle is demarcated at each predetermined angle.

FIG. 4 is a diagram showing an example of an image displayed on a display device 30a.

FIG. 5 is a diagram showing an occurrence probability at each azimuth degree more specifically.

FIG. 6 is a diagram showing an occurrence probability at each azimuth degree more specifically.

FIG. 7 is a diagram showing an example of an image displayed on the display device 30a in a scenario in which an action of a monitoring vehicle is predicted according to a situation of a lane.

FIG. 8 is a diagram showing another example of the image displayed on the display device 30a.

FIG. 9 is a diagram showing an example of an image projected to a front windshield.

FIG. 10 is a diagram showing other examples of images displayed on the display device 30a.

FIG. 11 is a diagram showing other examples of occurrence probabilities when an azimuth centering on a standard point of a monitoring vehicle is demarcated at each predetermined angle.

FIG. 12 is a diagram showing a configuration of a vehicle system 1A according to a second embodiment.

FIG. 13 is a diagram showing an aspect in which a relative position and an attitude of a own vehicle M with respect to a travel lane L1 are recognized by an own vehicle position recognizer 322.

FIG. 14 is a diagram showing an aspect in which a target trajectory is generated according to a recommended lane.

FIG. 15 is a diagram showing an example of an aspect in which a target trajectory is generated according to a prediction result by a prediction and derivation unit 351.

### DESCRIPTION OF EMBODIMENTS

Hereinafter, embodiments of a vehicle display control device, a vehicle display control method, and a vehicle display control program according to the present invention will be described with reference to the drawings.

### First Embodiment

FIG. 1 is a diagram showing a configuration of a vehicle system 1 including a vehicle display control device 100 according to a first embodiment. The vehicle on which the vehicle system 1 is mounted is, for example, a vehicle such as a two-wheeled vehicle, a three-wheeled vehicle, or a four-wheeled vehicle. A driving source of the vehicle M includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle system 1 includes, for example, a camera 10, a radar device 12, a finder 14, an object recognition device 16, a communication device 20, a human machine interface (HMI) 30, a vehicle sensor 40, and a vehicle display control device 100. The devices and units are connected to each other via a multiplex communication line such as a controller area network (CAN) communication line, a serial communication line, or a wireless communication network. The configuration shown in FIG. 1 is merely an exemplary example, a part of the configuration may be omitted, and another configuration may be further added.

The camera 10 is, for example, a digital camera that uses a solid-state image sensor such as a charged coupled device (CCD) or a complementary metal oxide semiconductor (CMOS). The single camera 10 or the plurality of cameras 10 are mounted in any portion of a vehicle on which the vehicle system 1 is mounted (hereinafter referred to as an own vehicle M). In the case of forward imaging, the camera 10 is mounted in an upper portion of a front windshield, a rear surface of a rearview mirror, or the like. For example, the camera 10 repeatedly images the periphery of the own vehicle M periodically. The camera 10 may be a stereo camera.

The radar device 12 radiates radio waves such as millimeter waves to the periphery of the own vehicle M and detects radio waves (reflected waves) reflected from an object to detect at least a position (a distance and an azimuth) of the object. The single radar device 12 or the plurality of radar devices 12 are mounted in any portion of the own vehicle M. The radar device 12 may detect a position and a speed of an object in conformity with a frequency modulated continuous wave (FM-CW) scheme.

The finder 14 is a light detection and ranging or a laser imaging detection and ranging (LIDAR) finder that measures scattered light of radiated light and detects a distance to a target. The single finder 14 or the plurality of finders 14 are mounted in any portion of the own vehicle M.

The object recognition device 16 executes a sensor fusion process on detection results from some or all of the camera 10, the radar device 12, and the finder 14 and recognizes a position, a type, a speed, and the like of an object. The object recognition device 16 outputs a recognition result to the vehicle display control device 100.

The communication device 20 communicates with other vehicles (which are example of nearby devices) near the own vehicle M using, for example, a cellular network, a Wi-Fi network, Bluetooth (registered trademark), dedicated short range communication (DSRC), or the like or communicates with various server devices via a wireless base station.

The HMI 30 presents various kinds of information to occupants of the own vehicle M and receives an input operation by the occupants. The HMI 30 includes, for example, a display device 30a. The HMI 30 may include a speaker, a buzzer, a touch panel, a switch, and a key (none of which is shown).

For example, the display device 30a is mounted in each unit of an instrument panel, any portion facing an assistant driver seat or a rear seat, or the like and is a liquid crystal display (LCD) or organic electroluminescence (EL) display device. The display device 30a may be a head-up display (HUD) that projects an image to the front windshield or another window. The display device 30a is an example of a “display.”

The vehicle sensor 40 includes a vehicle speed sensor that detects a speed of the own vehicle M, an acceleration sensor that detects acceleration, a yaw rate sensor that detects an angular velocity near a vertical axis, and an azimuth sensor that detects a direction of the own vehicle M. The vehicle sensor 40 outputs detected information (a speed, acceleration, an angular velocity, an azimuth, and the like) to the vehicle display control device 100.

The vehicle display control device 100 includes, for example, an external-world recognizer 101, a prediction and derivation unit 102, and a display controller 103. Some or all of these constituent elements are realized, for example, by causing a processor such as a central processing unit (CPU) to execute a program (software). Some or all of these constituent elements may be realized by hardware such as a large scale integration (LSI), an application specific integrated circuit (ASIC), or a field-programmable gate array (FPGA), or may be realized by software and hardware in cooperation.

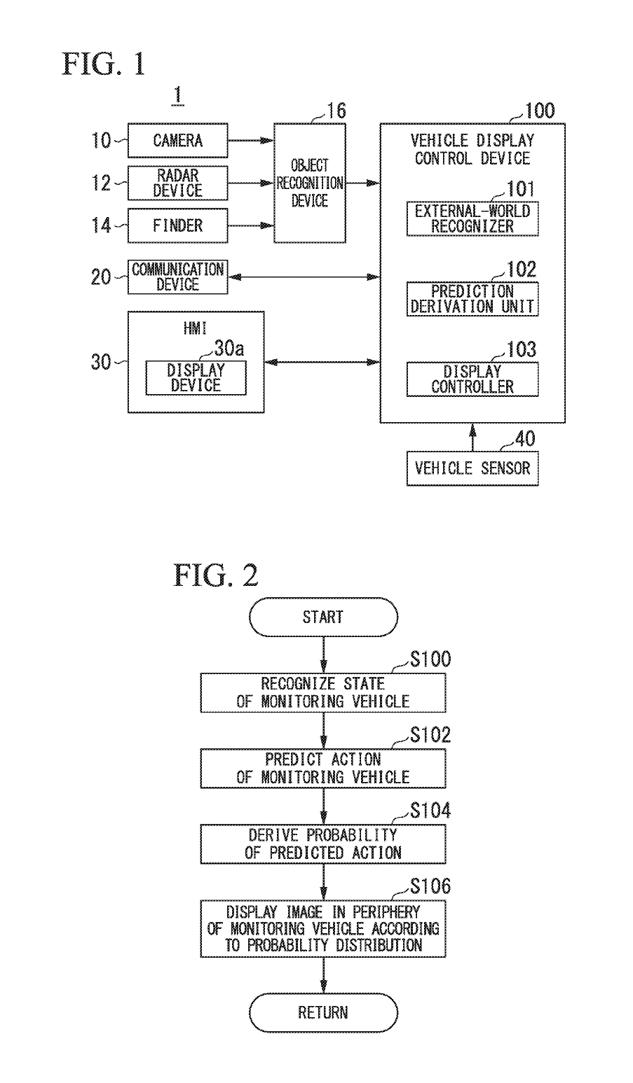

Hereinafter, each constituent element of the vehicle display control device 100 will be described with reference to a flowchart. FIG. 2 is a flowchart showing an example of a flow of a series of processes by the vehicle display control device 100 according to the first embodiment.

First, the external-world recognizer 101 recognizes a “state” of the monitoring vehicle according to information input directly from the camera 10, the radar device 12, and the finder 14 or via the object recognition device 16 (step S100). The monitoring device is one nearby device or nearby devices of which an influence on the own vehicle M is large and is equal to or less than a predetermined number (for example, three) among a plurality of nearby vehicles. The fact that “the influence on the own vehicle M is large” means, for example, that a control amount of an acceleration or deceleration speed or steering of the own vehicle M increases in accordance with an acceleration or deceleration speed or steering of the monitoring vehicle. The monitoring vehicle includes, for example, a front traveling vehicle that is traveling in the immediate front of the own vehicle M, a vehicle that is traveling in front of the own vehicle M along an adjacent lane adjacent to an own lane along which the own vehicle M is traveling, or a vehicle that is traveling side by side with the own vehicle M.

For example, the external-world recognizer 101 recognizes a position, a speed, acceleration, a jerk, or the like of a monitoring vehicle as the “state” of the monitoring vehicle. For example, the external-world recognizer 101 recognizes a relative position of the monitoring vehicle with respect to a road demarcation line for demarcating a lane along which the monitoring vehicle is traveling. The position of the monitoring vehicle may be represented as a representative point such as a center of gravity, a corner, or the like of the monitoring vehicle or may be represented as a region expressed by a contour of the monitoring vehicle. The external-world recognizer 101 may recognize flickering of various lamps such as head lamps mounted in the monitoring vehicle, tail lamps, or winkers (turn lamps) as the “state” of the monitoring vehicle.

Subsequently, the prediction and derivation unit 102 predicts a future action of the monitoring vehicle of which a state is recognized by the external-world recognizer 101 (step S102). For example, the prediction and derivation unit 102 predicts whether the monitoring vehicle changes a current lane to the own lane in future (the monitoring vehicle intrudes into the own lane) or predicts whether the monitoring vehicle changes a current lane to a lane which is not the own lane side in accordance with flickering of various lamps of the monitoring vehicle that is traveling along the adjacent lane.

The prediction and derivation unit 102 may predict whether the lane is changed according to a relative position of the monitoring vehicle to the lane along which the monitoring vehicle is traveling, irrespective of whether various lamps of the monitoring vehicle light or not. The details of the prediction according to the relative position of the monitoring vehicle to the lane will be described later.

For example, the prediction and derivation unit 102 predicts whether the monitoring vehicle is decelerating or accelerating in future according to a speed, an acceleration or deceleration speed, a jerk, or the like of the monitoring vehicle at a time point at which a state is recognized by the external-world recognizer 101.

The prediction and derivation unit 102 may predict whether the monitoring vehicle is accelerating or decelerating or changes its lane according to speeds, positions, or the like of other nearby vehicles except for the monitoring vehicle in future.

Subsequently, the prediction and derivation unit 102 derives a probability of a case in which the monitoring vehicle takes a predicted action (hereinafter referred to as an occurrence probability) (step S104). For example, the prediction and derivation unit 102 derives an occurrence probability of a predicted action at each azimuth centering on a standard point of the monitoring vehicle (for example, a center of gravity or the like). The occurrence probability is an example of “an index value obtained by quantifying a possibility of a future action being taken.”

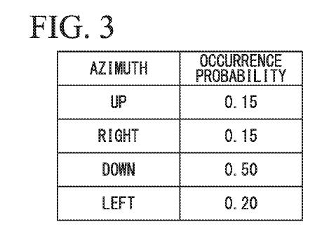

FIG. 3 is a diagram showing examples of occurrence probabilities (occurrence probability at each azimuth degree) when an azimuth centering on a standard point of a monitoring vehicle is demarcated at each predetermined angle. In the drawing, “up” indicates an azimuth to which a relative distance of the own vehicle M to the monitoring vehicle in a traveling direction of the monitoring vehicle increases, “down” indicates an azimuth to which the relative distance between the monitoring device and the own vehicle M in the traveling direction of the monitoring vehicle decreases. In addition, “right” indicates a right azimuth in the traveling direction of the monitoring vehicle and “left” indicates a left azimuth in the traveling direction of the monitoring vehicle.

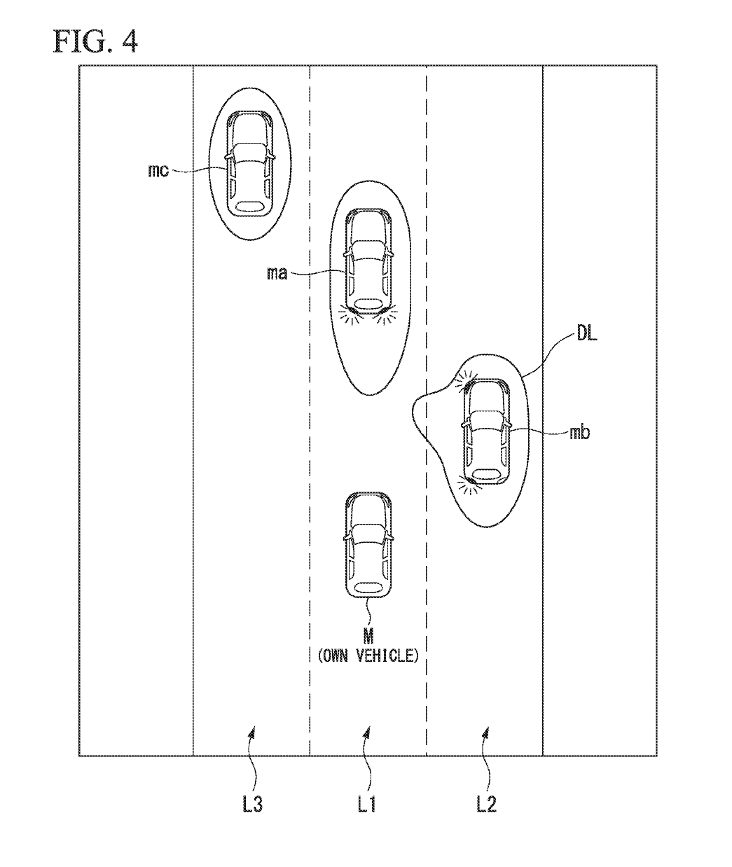

Subsequently, the display controller 103 controls the display device 30a such that an image in which an image element expressing an occurrence probability derived by the prediction and derivation unit 102 is disposed near the monitoring vehicle is displayed (step S106). For example, the display controller 103 causes the display device 30a to display an image in which a distribution curve DL according to the occurrence probability shown in FIG. 4 is disposed as an image element expressing an occurrence probability of each azimuth near the monitoring vehicle.

FIG. 4 is a diagram showing an example of the image displayed on the display device 30a. In the drawing, L1 represents an own lane, L2 represents a right adjacent lane in the traveling direction of the own vehicle M (hereinafter referred to as a right adjacent lane), and L3 represents a left adjacent lane in the traveling direction of the own vehicle M (hereinafter referred to as a left adjacent lane). In the drawing, ma represents a front traveling vehicle, mb represents a monitoring vehicle traveling along the right adjacent lane, and mc represents a monitoring vehicle traveling along the left adjacent lane.

For example, the display controller 103 controls the display device 30a such that an image in which the distribution curve DL indicating a distribution of occurrence probabilities is disposed near the monitoring vehicle is displayed near each monitoring vehicle. As a gap between the distribution curve DL and the monitoring vehicle is narrower, an action predicted at that azimuth more rarely occurs (an occurrence probability is lower). As the gap is broader, an action predicted at that azimuth more easily occurs (an occurrence probability is higher). That is, in the distribution curve DL, an expression aspect is changed step by step or continuously with a change in the occurrence probability. When the predicted action occurs, the magnitude of the occurrence probability of the action is expressed in the shape of a curve at each direction (azimuth) in which the monitoring vehicle is to move.

For example, when the front traveling vehicle ma is decelerating, for example, by performing braking, a relative position of the front traveling vehicle ma to the own vehicle M is closer to the own vehicle M. Therefore, as shown, the distribution curve DL near the front traveling vehicle ma is displayed in a state in which a gap from the front traveling vehicle ma is spread more in a region on the rear side of the front traveling vehicle ma. For example, when it is predicted that the monitoring vehicle mb traveling along the right adjacent lane L2 changes its lane to the own lane L1, as shown, the distribution curve DL near the monitoring vehicle mb is displayed in a shape in which the gap from the monitoring vehicle mb is spread more in a region on the left side of the monitoring vehicle mb. Thus, an occupant of the own vehicle M can be caused to intuitively recognize a future action of the nearby vehicle.

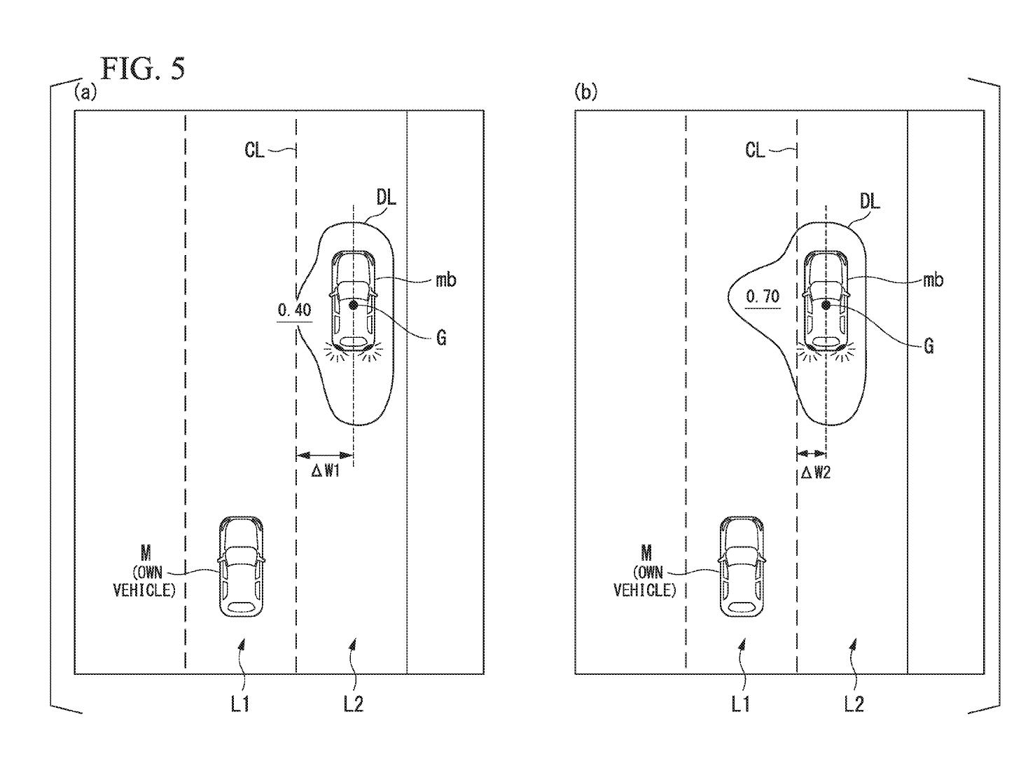

FIG. 5 is a diagram showing an occurrence probability at each azimuth degree more specifically. For example, the prediction and derivation unit 102 predicts an action of the monitoring vehicle in a lane width direction and derives an occurrence probability of the predicted action according to a relative position of the monitoring vehicle to a road demarcation line recognized by the external-world recognizer 101. In the drawing, CL represents a road demarcation line for demarcating a road demarcation line for demarcating the own lane L1 and the right adjacent lane L2 and G represents a center of gravity of the monitoring vehicle mb.

For example, when a distance ΔW1 between the road demarcation line CL and the center of gravity G in (a) of the drawing is compared to a distance ΔW2 between the road demarcation line CL and the center of gravity G in (b) of the drawing, the distance ΔW2 can be understood to be shorter. In this case, a situation indicated in (b) can be determined to have a higher possibility of the monitoring vehicle mb changing its lane to the own lane L1 than a situation shown in (a). Accordingly, the prediction and derivation unit 102 predicts that the monitoring vehicle mb changes its lane at a higher probability in the situation indicated in (b) than in the situation indicated in (a), irrespective of whether there is lighting or the like of various lamps by the monitoring vehicle mb. In other words, the prediction and derivation unit 102 derives a higher occurrence probability of an action in the lane width direction (a direction in which the monitoring vehicle mb approaches the own lane L1) in the situation indicated in (b) than in the situation indicated in (a). The prediction and derivation unit 102 may derive a further higher occurrence probability when the monitoring vehicle lights various lamps. In the shown example, an occurrence probability in the direction in which in the monitoring vehicle mb approaches the own lane L1 is derived to 0.40 in the situation of (a) and is derived to 0.70 in the situation of (b). These occurrence probabilities may be displayed along with the distribution curve DL, as shown, or may be displayed alone. Thus, a gap between the own vehicle M and the monitoring vehicle mb in the lane width direction becomes larger, and thus the distribution curve DL in (b) can prompt the occupant of the own vehicle M to be careful about the nearby vehicle predicted to becomes closer to the own vehicle M.

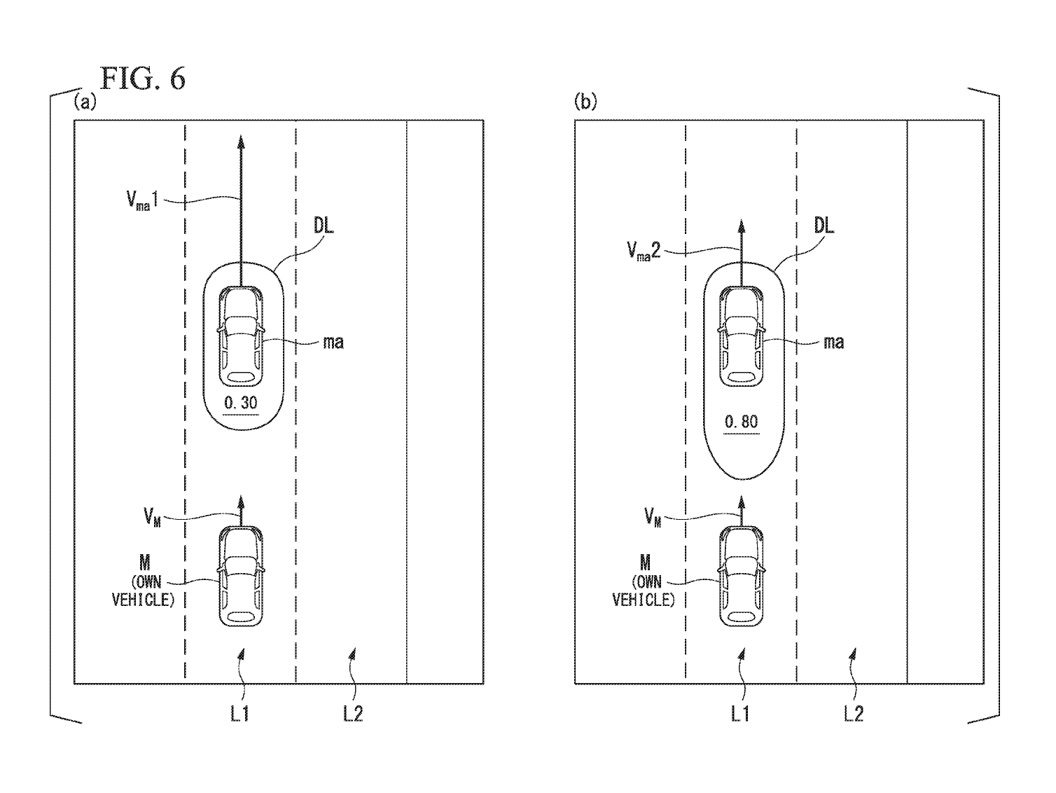

FIG. 6 is a diagram showing an occurrence probability at each azimuth degree more specifically. For example, the prediction and derivation unit 102 predicts an action of the monitoring vehicle in the vehicle traveling direction according to the speed of the monitoring vehicle recognized by the external-world recognizer 101 and the speed of the own vehicle M detected by the vehicle sensor 40 and derives an occurrence probability of the predicted action. In the drawing, VM represents the magnitude of a speed of the own vehicle M, Vma1 and Vma2 represent the magnitudes of speeds of the front traveling vehicle ma.

For example, when a relative speed (Vma1−VM) in a situation of (a) in the drawing is compared to a relative speed (Vma2−VM) in a situation of (b) in the drawing, the relative speed (Vma2−VM) can be understood to be less. In this case, the situation indicated in (b) can be determined to have a higher possibility of an inter-vehicle distance with the front traveling vehicle ma being narrower at a future time point than the situation indicated in (a). Accordingly, the prediction and derivation unit 102 predicts that the monitoring vehicle mb is decelerating at a high probability in the situation indicated in (b) than in the situation indicated in (a). In other words, the prediction and derivation unit 102 derives a higher occurrence probability of the action in a vehicle traveling direction (a direction in which the front traveling vehicle ma approaches the own vehicle M) in the situation indicated in (b) than in the situation indicated in (a). In the shown example, the occurrence probability in the direction in which the front traveling vehicle ma approaches the own vehicle M is derived to 0.30 in the situation of (a) and is derived to 0.80 in the situation of (b). Thus, since a gap between the own vehicle M and the front traveling vehicle ma in the vehicle traveling direction becomes larger, the distribution curve DL in (b) can prompt the occupant of the own vehicle M to be careful about the nearby vehicle predicted to becomes closer to the own vehicle M.

The prediction and derivation unit 102 may predict an action of the monitoring vehicle in the vehicle traveling direction according to an inter-vehicle distance between the monitoring vehicle and the own vehicle M or a relative acceleration or deceleration speed instead of or in addition to the relative speed of the own vehicle M to the monitoring vehicle M and may derive an occurrence probability of the predicted action.

The prediction and derivation unit 102 may predict an action of the monitoring vehicle in the vehicle traveling direction or the lane width direction based in a situation of the lane along which the monitoring vehicle is traveling and may derive an occurrence probability of the predicted action.

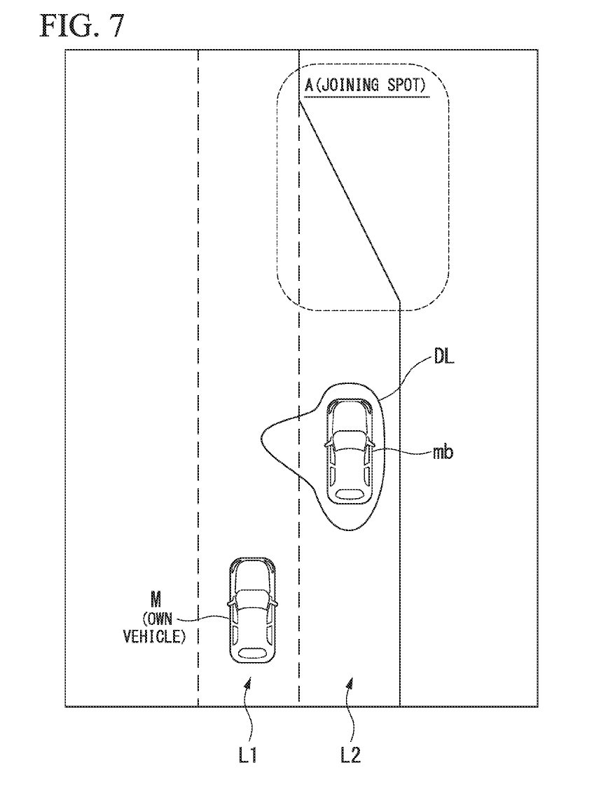

FIG. 7 is a diagram showing an example of an image displayed on the display device 30a in a scene in which an action of a monitoring vehicle is predicted according to a situation of a lane. In the drawing, A represents a spot in which the right adjacent lane L2 is tapered and joins to another lane (hereinafter referred to as a joining spot). For example, the external-world recognizer 101 may recognize the joining spot A by referring to map information including information regarding the joining spot A or may recognize the joining spot A from a pattern of a road demarcation line recognized from an image captured by the camera 10. When a wireless device that notifies of a traffic situation of a road is installed on a road side of the road and the communication device 20 performs wireless communication with the wireless device, the external-world recognizer 101 may recognize the joining spot A by acquiring information transmitted from the wireless device via the communication device 20.

At this time, the external-world recognizer 101 or the prediction and derivation unit 102 may also recognize, for example, a lane along which the own vehicle M is traveling (traveling lane) and a relative position and an attitude of the own vehicle M with respect to the traveling lane.

When the external-world recognizer 101 recognizes that there is the joining spot A in front of the lane along which the monitoring vehicle mb is traveling, the prediction and derivation unit 102 predicts that the monitoring vehicle mb changes its lane to the own lane L1 at a high probability. At this time, the prediction and derivation unit 102 may predict that the monitoring vehicle mb is accelerating or decelerating in accordance with the change in the lane. Thus, for example, even in a state in which the monitoring vehicle mb does not light winkers or the like, the action of the monitoring vehicle mb is predicted and an action to be taken in future can be expressed in a shape of the distribution curve DL of the occurrence probability.

The external-world recognizer 101 may recognize a branching spot, an accident occurrence spot, or a spot which interrupts traveling of the monitoring vehicle, such as a tollgate, instead of the joining spot A. In response to this, the prediction and derivation unit 102 may predict that the monitoring vehicle is changing its lane, accelerating, or decelerating in front of the spot that interrupts the traveling of the monitoring vehicle.

The prediction and derivation unit 102 may determine whether a future action of the monitoring vehicle recognized by the external-world recognizer 101 is an action of which an influence on the own vehicle M is higher than a standard value or an action of which the influence is less than the standard value.

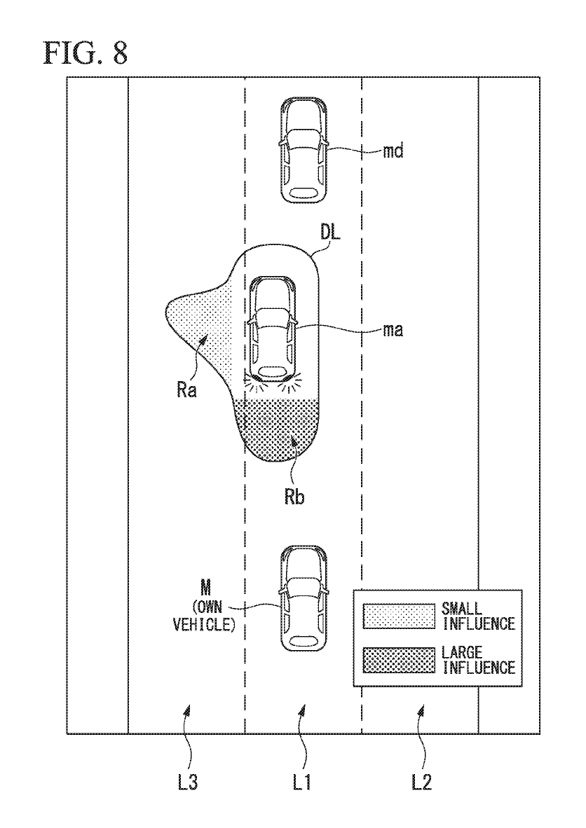

FIG. 8 is a diagram showing another example of the image displayed on the display device 30a. An shown situation is a situation in which the front traveling vehicle ma is trying to overtake a front vehicle md. For example, when the front traveling vehicle ma nears one side of the lane to overtake the front vehicle md, the vehicle md which is hidden by the front traveling vehicle ma on an image captured by the camera 10 and has not been recognized is recognized at a certain timing. At this time, the prediction and derivation unit 102 predicts that the front traveling vehicle ma changes its lane to an adjacent lane for a moment to overtake the vehicle md. That is, the prediction and derivation unit 102 predicts “a lane change to an adjacent lane” and “acceleration or deceleration” as actions of the front traveling vehicle ma. Since “deceleration” of the front traveling vehicle ma is an action in which the front traveling vehicle ma relatively approaches the own vehicle M, the prediction and derivation unit 102 determines that the action by the front traveling vehicle ma is an action of which the influence on the own vehicle M is higher than the standard value. A direction in which the front traveling vehicle ma is relatively closer to the own vehicle M is an example of a “direction in which the influence on the own vehicle is higher than the standard value.”

Since “the acceleration” or “the lane change to an adjacent lane” of the front traveling vehicle ma is an action in which the front traveling vehicle ma is relatively away from the own vehicle M, the prediction and derivation unit 102 determines that the action by the front traveling vehicle ma is an action of which the influence on the own vehicle M is less than the standard value. A direction in which the front traveling vehicle ma is relatively away from the own vehicle M is an example of a “direction in which the influence on the own vehicle is less than the standard value.”

When the speed of the front traveling vehicle ma is a constant speed with the own vehicle M, an action by the front traveling vehicle ma is determined to be an action of which the influence on the own vehicle M is about the standard value.

In response to this, the display controller 103 changes a display aspect in accordance with the influence of the action by the monitoring vehicle on the own vehicle M. In the shown example, a region Ra of a probability distribution corresponding to a direction in which the front traveling vehicle ma relatively moves by the “acceleration or deceleration” and a region Rb of a probability distribution corresponding to a direction in which the front traveling vehicle ma relatively moves by the “lane change” are displayed to be distinguished with colors, shapes, or the like. As a result, the occupant of the own vehicle M can be caused to intuitively recognize an influence of a future action of a nearby vehicle on the own vehicle M (for example, safety or danger).

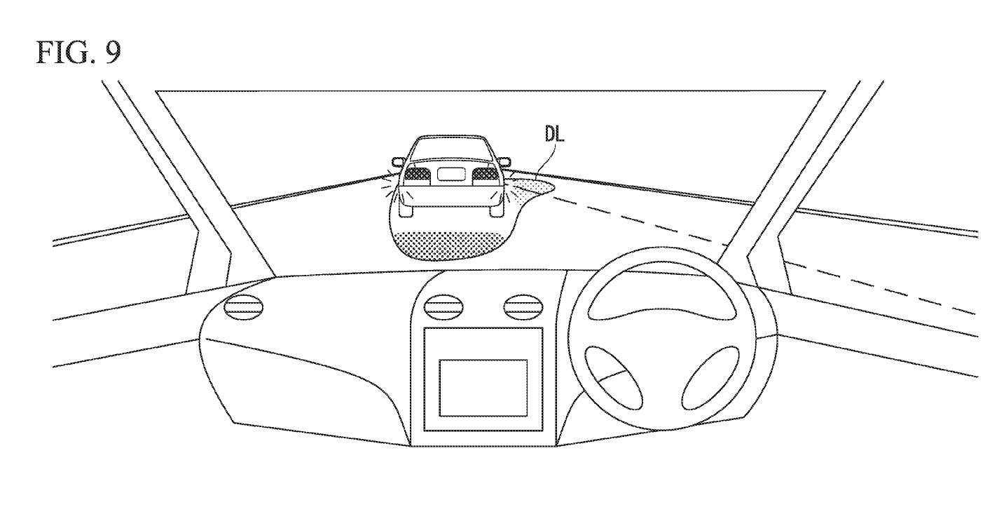

The display controller 103 may cause the HUD to project an image representing the distribution curve DL of the above-described occurrence probability to the front windshield. FIG. 9 is a diagram showing an example of an image projected to the front windshield. As shown, for example, the distribution curve DL may be projected to the front windshield in accordance with a vehicle body reflection of the front traveling vehicle or the like.

In the above-described various examples, the display controller 103 displays the distribution curve DL in which an occurrence probability of a future action of the monitoring vehicle is represented as a distribution in each direction (azimuth) in which the monitoring vehicle moves in accordance with the future action, but the present invention is not limited thereto. For example, the display controller 103 may represent the occurrence probability of the future action of the monitoring vehicle in a specific sign, figure, or the like.

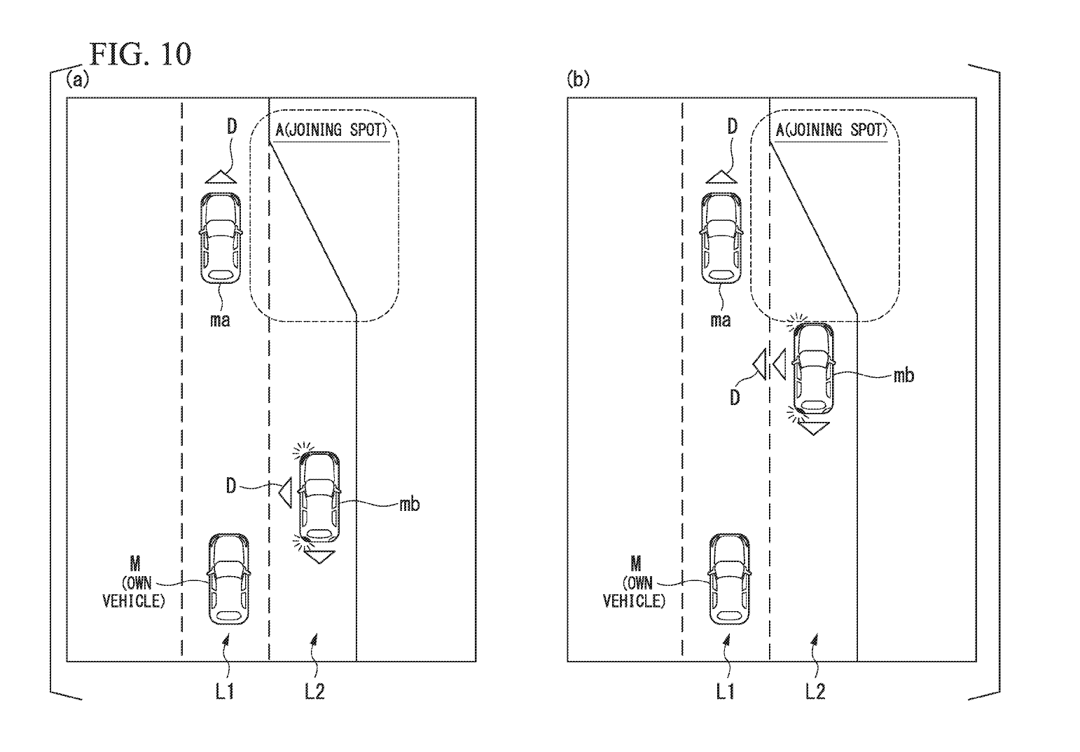

FIG. 10 is a diagram showing other examples of images displayed on the display device 30a. As in the shown example, the display controller 103 expresses the height of the occurrence probability of a future action predicted by the prediction and derivation unit 102 and a direction in which the monitoring vehicle moves in accordance with the action in an orientation and the number of triangles D. For example, in a scene indicated in (b), the monitoring vehicle mb traveling along the right adjacent lane L2 is nearer to the joining spot A and thus a probability at which the lane is change is higher than in a scene indicated in (a). Accordingly, the display controller 103 causes the occupant of the own vehicle M to recognize how much easily a predicted action occurs, for example, by increasing the number of triangles D. The display controller 103 may display a specific sign, figure, or the like only in the direction (azimuth) in which the occurrence probability of the predicted future action is the highest or may display the sign, the figure, or the like to flicker.

In the above-described embodiment, as described above, the prediction and derivation unit 102 predicts the future action of the monitoring vehicle according to the recognition result by the external-world recognizer 101, but the present invention is not limited thereto. For example, when the communication device 20 performs inter-vehicle communication with a monitoring vehicle, the prediction and derivation unit 102 may receive information regarding a future action schedule from the monitoring vehicle through the inter-vehicle communication and may predict a future action of the monitoring vehicle according to the received information. When the information regarding the future action schedule is uploaded from the monitoring vehicle to any of various server devices, the prediction and derivation unit 102 may communicate with the server device via the communication device 20 to acquire the information regarding the future action schedule.

In the above-described embodiment, as described above, the image in which the image in which the image element according to the occurrence probability of the action is disposed is disposed near the monitoring vehicle is simply displayed, but the present invention is not limited thereto. For example, the display controller 103 may multiply or add not only the occurrence probability but also a displacement amount of the monitoring vehicle at that time point as an assumed displacement amount at a certain future time point to a probability and may handle the calculation result as a “probability” of the foregoing embodiment. The assumed displacement amount at the certain future time point may be estimated according to, for example, a model obtained from a jerk, acceleration, or the like of the monitoring vehicle at a prediction time point.

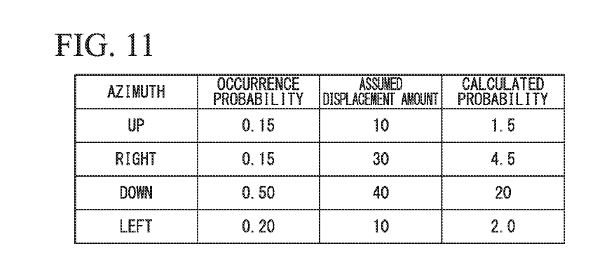

FIG. 11 is a diagram showing other examples of occurrence probabilities when an azimuth centering on a standard point of a monitoring vehicle is demarcated at each predetermined angle. In the shown example, a multiplication result of the occurrence probability and the assumed displacement amount at the certain future time point is handled as a “probability” at the time of displaying the distribution curve DL. In this case, the “probability” which is a calculation result may exceed 1.

According to the above-described first embodiment, it is possible to provide a sense of security to an occupant of the own vehicle M by predicting a future action of the nearby vehicle near the own vehicle M, deriving the occurrence probability of the predicted future action being taken, and causing the display device 30a to display the image in which the image element according to the occurrence probability is disposed near the monitoring vehicle. For example, it is possible to cause the occupant of the own vehicle M to intuitively recognize the future action of the nearby vehicle by displaying, as the image element according to the occurrence probability, the distribution curve DL in which occurrence probability of the future action of the monitoring vehicle is represented as a distribution in each direction (azimuth) in which the monitoring vehicle moves in accordance with the future action.

### Second Embodiment

Hereinafter, a second embodiment will be described. In the first embodiment, the display control device simply mounted in a vehicle has been described. In the second embodiment, an example in which the display control device is applied to an automatic driving vehicle will be described. Hereinafter, differences from the first embodiment will be mainly described and the description of the common functions or the like to the first embodiment will be omitted.

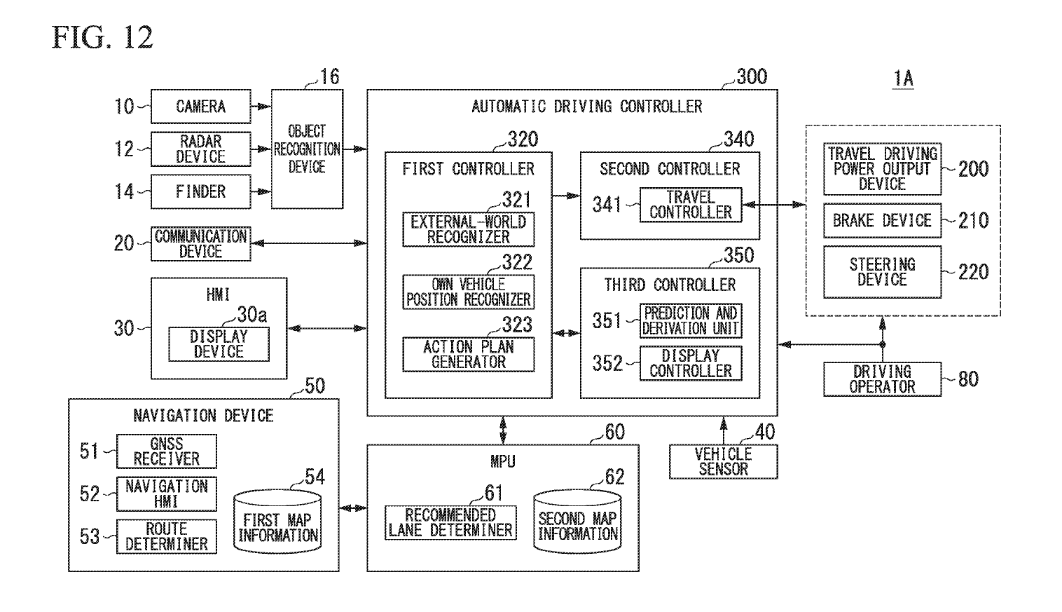

FIG. 12 is a diagram showing a configuration of a vehicle system 1A according to a second embodiment. The vehicle system 1A according to the second embodiment includes, for example, a navigation device 50, a micro-processing unit (MPU) 60, a driving operator 80, a travel driving power output device 200, a brake device 210, a steering device 220, and an automatic driving controller 300 in addition to the camera 10, the radar device 12, the finder 14, the object recognition device 16, the communication device 20, the HMI 30 including the display device 30a, and the vehicle sensor 40 described above. The devices and units are connected to each other via a multiplex communication line such as a controller area network (CAN) communication line, a serial communication line, or a wireless communication network. The configuration shown in FIG. 12 is merely an exemplary example, a part of the configuration may be omitted, and another configuration may be further added.

The navigation device 50 includes, for example, a global navigation satellite system (GNSS) receiver 51, a navigation HMI 52, and a route determiner 53 and retains first map information 54 in a storage device such as a hard disk drive (HDD) or a flash memory. The GNSS receiver 51 specifies a position of the own vehicle M according to signals received from GNSS satellites. The position of the own vehicle M may be specified or complemented by an inertial navigation system (INS) using an output of the vehicle sensor 40. The navigation HMI 52 includes a display device, a speaker, a touch panel, and a key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 with reference to the first map information 54. The first map information 54 is, for example, information in which a road form is expressed by links indicating roads and nodes connected by the links. The first map information 54 may include curvatures of roads and point of interest (POI) information. The route determined by the route determiner 53 is output to the MPU 60. The navigation device 50 may execute route guidance using the navigation HMI 52 according to the route determined by the route determiner 53. The navigation device 50 may be realized by, for example, a function of a terminal device such as a smartphone or a tablet terminal possessed by a user. The navigation device 50 may transmit a current position and a destination to a navigation server via the communication device 20 to acquire a route with which the navigation server replies.

The MPU 60 functions as, for example, a recommended lane determiner 61 and retains second map information 62 in a storage device such as an HDD or a flash memory. The recommended lane determiner 61 divides a route provided from the navigation device 50 into a plurality of blocks (for example, divides the route in a vehicle movement direction every 100 [m]) and determines a recommended lane for each block with reference to the second map information 62. For example, when there are a plurality of lanes in the route supplied from the navigation device 50, the recommended lane determiner 61 determines one recommended lane among the plurality of lanes. When there is a branching spot, a joining spot, or the like on the supplied route, the recommended lane determiner 61 determines a recommended lane so that the own vehicle M can travel along a reasonable travel route for moving to a branching destination.

The second map information 62 is map information with higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The road information includes information indicating kinds of roads such as expressways, toll roads, national roads, or prefecture roads and information such as the number of lanes of a road, the width of each lane, the gradients of roads, the positions of roads (3-dimensional coordinates including longitude, latitude, and height), curvatures of curves of lanes, positions of joining and branching points of lanes, and signs installed on roads. The second map information 62 may be updated frequently when the communication device 20 is used to access other devices.

The driving operator 80 includes, for example, an accelerator pedal, a brake pedal, a shift lever, and a steering wheel. A sensor that detects whether there is an operation or an operation amount is mounted in the driving operator 80 and a detection result is output to the automatic driving controller 300, the travel driving power output device 200, or one or both of the brake device 210, and the steering device 220.

The travel driving power output device 200 outputs travel driving power (torque) for causing the vehicle to travel to a driving wheel. The travel driving power output device 200 includes, for example, a combination of an internal combustion engine, an electric motor and a transmission, and an electronic controller (ECU) controlling these units. The ECU controls the foregoing configuration in accordance with information input from the travel controller 341 or information input from the driving operator 80.

The brake device 210 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the travel controller 341 or information input from the driving operator 80 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the travel controller 341 such that a hydraulic pressure of the master cylinder is transmitted to the cylinder.

The steering device 220 includes, for example, a steering ECU and an electric motor. The electric motor exerts a force on, for example, a rack and pinion mechanism to change a direction of a steering wheel. The steering ECU drives the electric motor to change the direction of the steering wheel in accordance with information input from the travel controller 341 or information input from the driving operator 80.

The automatic driving controller 300 includes, for example, a first controller 320, a second controller 340, and a third controller 350. The first controller 320, the second controller 340, and the third controller 350 are each realized by causing a processor such as a CPU to execute a program (software). Some or all of the constituent elements of the first controller 320, the second controller 340, and the third controller 350 to be described below may be realized by hardware such as LSI, ASIC, or FPGA or may be realized by software and hardware in cooperation.

The first controller 320 includes, for example, an external-world recognizer 321, an own vehicle position recognizer 322, and an action plan generator 323. The external-world recognizer 321 performs a similar process to that of the external-world recognizer 101 in the above-described first embodiment, and therefore the description thereof will be omitted here.

The own vehicle position recognizer 322 recognizes, for example, a lane in which the own vehicle M is traveling (a traveling lane) and a relative position and an attitude of the own vehicle M with respect to the travel lane. The own vehicle position recognizer 322 recognizes a traveling lane, for example, by comparing patterns of road demarcation lines (for example, arrangement of continuous lines and broken lines) obtained from the second map information 62 with patterns of road demarcation lines near the own vehicle M recognized from images captured by the camera 10. In this recognition, a position of the own vehicle M acquired from the navigation device 50 or a process result by INS may be added.

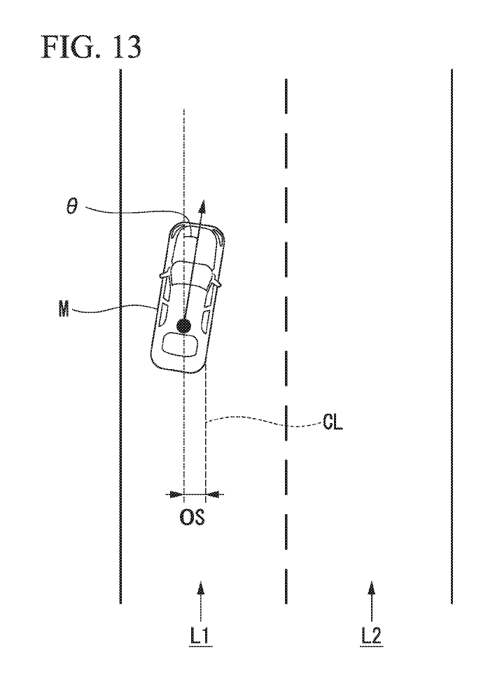

Then, the own vehicle position recognizer 322 recognizes, for example, a position or an attitude of the own vehicle M with respect to the traveling lane. FIG. 13 is a diagram showing an aspect in which a relative position and an attitude of the own vehicle M with respect to a traveling lane L1 are recognized by the own vehicle position recognizer 322. The own vehicle position recognizer 322 recognizes, for example, a deviation OS of the standard point (for example, a center of gravity) of the own vehicle M from a traveling lane center CL and an angle θ formed with a line drawn from the traveling lane center CL in the traveling direction of the own vehicle M as a relative position and an attitude of the own vehicle M with respect to the traveling lane L1. Instead of this, the own vehicle position recognizer 322 may recognize a position or the like of the standard point of the own vehicle M with respect to one side end portion of the own lane L1 as a relative position of the own vehicle M with respect to the traveling lane. The relative position of the own vehicle M recognized by the own vehicle position recognizer 322 is supplied to the recommended lane determiner 61 and the action plan generator 323.

The action plan generator 323 determines events which are sequentially executed in automatic driving so that the own vehicle M travels in the recommended lane determined by the recommended lane determiner 61 and nearby situations of the own vehicle M can be handled. The automatic driving is control of at least one of an acceleration/deceleration or steering of the own vehicle M by the automatic driving controller 300. As the events, for example, there are a constant speed traveling event of traveling at a constant speed in the same travel lane, a following travel event of following a preceding vehicle, a lane changing event, a joining event, a branching event, an emergency stopping event, and a switching event of ending automatic driving and switching to manual driving (a takeover event). When such an event is being executed, an action for avoidance is planned in some cases according to a nearby situation (presence of a nearby vehicle or a pedestrian, narrowing of a lane due to road construction, or the like) of the own vehicle M.

The action plan generator 323 generates a target trajectory along which the own vehicle M will travel in future. The target trajectory is expressed by arranging spots (trajectory points) at which the own vehicle M arrives in order. The trajectory points are spots at which the own vehicle M arrives every predetermined traveling distance. Apart from this, a target speed and target acceleration for each predetermined sampling period (for example, about 0 decimal point [sec]) is generated as a part of the target trajectory. The trajectory point may be a position for each predetermined sampling time at which the own vehicle M arrives at the sampling time. In this case, information regarding the target speed or the target acceleration is expressed at an interval of the trajectory point.

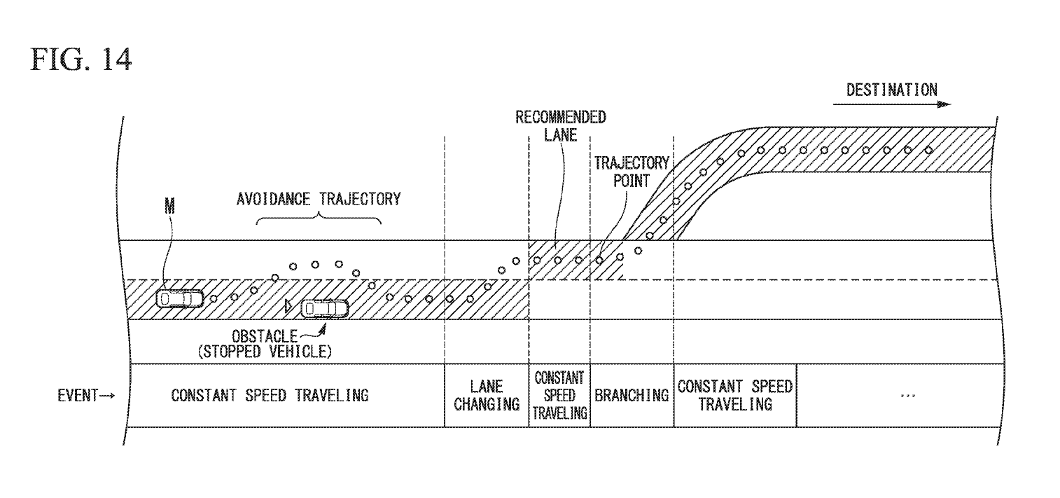

FIG. 14 is a diagram showing an aspect in which a target trajectory is generated according to a recommended lane. As shown, the recommended lane is set so that a condition of traveling along a route to a designation is good. The action plan generator 323 activates a lane changing event, a branching event, a joining event, or the like when the own vehicle arrives a predetermined distance in front of a switching spot of the recommended lane (which may be determined in accordance with a type of the event). When it is necessary to avoid an obstacle while each event is being executed, an avoidance trajectory is generated, as shown.

The action plan generator 323 generates, for example, a plurality of target trajectory candidates and selects an optimum target trajectory at that time on the basis of a viewpoint of safety and efficiency.

The second controller 340 includes a travel controller 341. The travel controller 341 controls the travel driving power output device 200 and one or both of the brake device 210 and the steering device 220 so that the own vehicle M passes along a target trajectory generated by the action plan generator 323 at a scheduled time.

The third controller 350 includes a prediction and derivation unit 351 and a display controller 352. The prediction and derivation unit 351 and the display controller 352 perform similar processes to those of the prediction and derivation unit 102 and the display controller 103 according to the above-described first embodiment. The prediction and derivation unit 351 outputs an occurrence probability of a predicted future action of a monitoring vehicle and information regarding a direction (azimuth) in which the monitoring vehicle moves in accordance with the future action (for example, the information shown in FIG. 3 or 11 described above) to the action plan generator 323. In response to this, the action plan generator 323 regenerates a target trajectory on the basis of the occurrence probability of the future action of the monitoring device predicted by the prediction and derivation unit 351 and the direction in which the monitoring vehicle moves in accordance with the action.

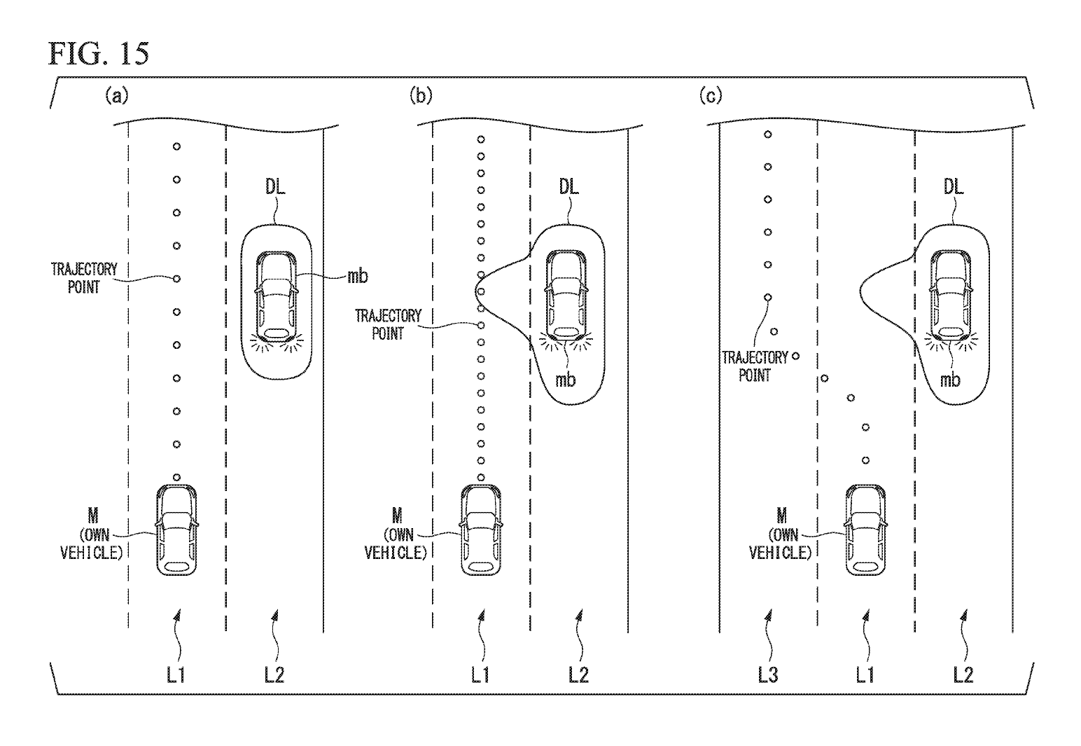

FIG. 15 is a diagram showing an example of an aspect in which a target trajectory is generated according to a prediction result by the prediction and derivation unit 351. For example, as in (a) of the drawing, when the action plan generator 323 generates a target trajectory by disposing trajectory points at a constant interval as a constant speed traveling event, it is assumed that the prediction and derivation unit 351 predicts that the monitoring vehicle mb changes its lane to the own lane L1. At this time, as in (b) of the drawing, the action plan generator 323 regenerates a target trajectory in which the disposition interval of the trajectory points is narrower than the disposition interval of the trajectory points at the time of (a). Thus, the own vehicle M can decelerate in advance to prepare for intrusion of the monitoring vehicle mb. As in (c) of the drawing, the action plan generator 323 may regenerate a target trajectory in which the disposition of the trajectory points is changed to a left adjacent lane L3 of the own lane L1. Thus, the own vehicle M can escape to another lane before the monitoring vehicle mb intrudes in front of the own vehicle M.

According to the above-described second embodiment, as in the above-described first embodiment, it is possible to provide a sense of security to the occupant of the own vehicle M by causing the display device 30a to display an image in which an image element according to an occurrence probability is disposed near a monitoring vehicle.

According to the second embodiment, since automatic driving is performed according to a future action of a monitoring vehicle predicted by the automatic driving controller 300 and an image according to an occurrence probability of a future action of the monitoring vehicle is displayed, the occupant of the own vehicle M can ascertain a causal relation between an action of the nearby vehicle and an action of the own vehicle M at the time of the automatic driving. As a result, it is possible to further provide a sense of security to the occupant of the own vehicle M.

While preferred embodiments of the invention have been described and shown above, it should be understood that these are exemplary examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1, 1A Vehicle system
10 Camera
12 Radar device
14 Finder
16 Object recognition device
20 Communication device
30 HMI
30a Display device
40 Vehicle sensor
50 Navigation device
51 GNSS receiver
52 Navigation HMI
53 Route determiner
54 First map information
60 MPU
61 Recommended lane determiner
62 Second map information
80 Driving operator
100 Vehicle display control device
101 External-world recognizer
102, 351 Prediction and derivation unit
103, 352 Display controller
200 Travel driving force output device
210 Brake device
220 Steering device
300 Automatic driving controller
320 First controller
321 External-world recognizer
322 Own vehicle position recognizer
323 Action plan generator
340 Second controller
341 Travel controller
350 Third controller

What is claim is:

1.-14. (canceled)

15. A vehicle display control device comprising:
a prediction and derivation unit configured to predict a future action of a nearby vehicle near an own vehicle and derive an index value obtained by quantifying a possibility of the predicted future action being taken; and
a display controller configured to cause a display to display an image in which an image element according to the index value obtained by quantifying the possibility of the future action being taken for each nearby vehicle and derived by the prediction and derivation unit is associated with the nearby vehicle,
wherein the display controller is configured to change an expression aspect of the image element step by step or continuously with a change in the index value corresponding to a future action of each nearby vehicle and derived by the prediction and derivation unit.

16. The vehicle display control device according to claim 15,
wherein the prediction and derivation unit is configured to predict a plurality of future actions of the nearby vehicle and derive the index value of each of the plurality of predicted future actions, and
wherein the display controller is configured to cause the display to display the image in which the image element according to the index value of each future action of the nearby vehicle and derived by the prediction and derivation unit is associated with the nearby vehicle.

17. The vehicle display control device according to claim 16, wherein the display controller is configured to change an expression aspect of the corresponding image element between an action in a direction in which an influence on the own vehicle is less than a standard value and an action in a direction in which the influence on the own vehicle is greater than the standard value among the plurality of future actions of the nearby vehicle.

18. The vehicle display control device according to claim 16, wherein the display controller is configured to cause the display to display an image in which an image element according to the index value corresponding to an action in a direction in which an influence on the own vehicle is greater than the standard value among the plurality of future actions of the nearby vehicle is associated with the nearby vehicle.

19. The vehicle display control device according to claim 18, wherein the display controller is further configured to cause the display to display an image in which an image element according to the index value corresponding to an action in a direction in which the influence on the own vehicle is less than the standard value among the plurality of future actions of the nearby vehicle is associated with the nearby vehicle.

20. The vehicle display control device according to claim 17, wherein the action in the direction in which the influence on the own vehicle is greater than the standard value is an action in which the nearby vehicle relatively approaches the own vehicle.

21. The vehicle display control device according to claim 17, wherein the action in the direction in which the influence on the own vehicle is greater than the standard value is an action in which the nearby vehicle intrudes in front of the own vehicle.

22. The vehicle display control device according to claim 15, wherein the prediction and derivation unit is configured to predict a future action of a nearby vehicle of which an influence on the own vehicle is greater than a standard value.

23. The vehicle display control device according to claim 22, wherein the nearby vehicle of which the influence on the own vehicle is greater than the standard value includes at least one of
a front traveling vehicle traveling immediately in front of the own vehicle and,
in a lane adjacent to a lane in which the own vehicle is traveling, a vehicle traveling in front of the own vehicle or a vehicle traveling side by side with the own vehicle.

24. The vehicle display control device according to claim 15, wherein the prediction and derivation unit is configured to derive the index value according to a relative speed of the own vehicle to the nearby vehicle, an inter-vehicle distance between the own vehicle and the nearby vehicle, or an acceleration or deceleration speed of the nearby vehicle.

25. The vehicle display control device according to claim 15, wherein the prediction and derivation unit is configured to derive the index value according to a situation of a lane along which the nearby vehicle is traveling.

26. A vehicle display control method of causing an in-vehicle computer mounted in a vehicle that includes a display to:
predict a future action of a nearby vehicle near an own vehicle;
derive an index value obtained by quantifying a possibility of the predicted future action being taken; and
cause the display to display an image in which an image element according to the derived index value obtained by quantifying the possibility of the future action being taken for each nearby vehicle is associated with the nearby vehicle,
wherein an expression aspect of the image element is changed step by step or continuously with a change in the derived index value corresponding to the future action of each nearby vehicle.

27. A computer-readable non-transitory storage medium storing a vehicle display control program causing an in-vehicle computer mounted in a vehicle that includes a display to perform:
a process of predicting a future action of a nearby vehicle near an own vehicle;
a process of deriving an index value obtained by quantifying a possibility of the predicted future action being taken; and
a process of causing the display to display an image in which an image element according to the derived index value obtained by quantifying the possibility of the future action being taken for each nearby vehicle is associated with the nearby vehicle; and
a process of changing an expression aspect of the image element step by step or continuously with a change in the derived index value corresponding to the future action of each nearby vehicle.
